(19) United States
(12) Patent Application Publication
(10) Pub. No.: US 2011/0064915 A1
(43) Pub. Date: Mar. 17, 2011

(54) METAL WORKPIECE WITH THREE-DIMENSIONAL PATTERN AND PRODUCTION METHOD THEREOF

(75) Inventors: Chien-Min Chang, Taipei City (TW); Wan-Li Chuang, Taipei City (TW); Jung-Chin Wu, Taipei City (TW)

(73) Assignee: COMPAL ELECTRONICS, INC., Taipei City (TW)

(21) Appl. No.: 12/881,185

(22) Filed: Sep. 14, 2010

Related U.S. Application Data
(60) Provisional application No. 61/241,962, filed on Sep. 14, 2009.

(51) Int. Cl. B32B 3/30; B32B 38/06; B32B 38/04; B32B 38/14

(52) U.S. Cl. 428/172; 156/220

(57) ABSTRACT

A production method of metal workpiece is provided. First, an adhesive layer is applied on a metal workpiece. The adhesive layer is impressed by a mold, so that the adhesive layer forms a three-dimensional pattern. The adhesive layer is then cured by implementing a plurality of heat treatments thereon. A metal workpiece with three-dimensional pattern is also provided.

### CROSS-REFERENCE TO RELATED APPLICATION

This application claims priority benefits of U.S. Patent Provisional Application No. 61/241,962, filed on Sep. 14, 2009. The entirety of the above-mentioned patent applications is hereby incorporated by reference herein and made a part of this specification.

### BACKGROUND OF THE INVENTION

1. Field of the Invention

The invention generally relates to a production method of a metal workpiece, and more particularly to a method of producing a three-dimensional pattern on a surface of a metal workpiece.

2. Description of Related Art

Currently, electronic devices such as notebook computers, mobile phones, or digital cameras mostly adopt metal material for constituting the exterior. In order to advance the overall aesthetic appearance of electronic devices, various patterns are usually formed on the appealing configuration. Patterns are produced on the surface of metal material frequently by etching metal material with a solvent or by paint-spraying and transfer printing. Nonetheless, the surface treatment technique of the former is complicated and difficult, and the production thereof is highly contaminative. The latter is restrained by the chemical property of metal material, such that artistic configuration cannot be produced.

If patterns are formed on a plastic casing, IMD (In Mold Decoration), such as IMR (In Mold Roller) or IMF (In Mold Film), is commonly used which bonds a decoration stack having patterns therein to the plastic casing by injection molding. However, the method requires high adhesion for each layer of the decoration stack so that shedding problem often arise in practice.

### SUMMARY OF THE INVENTION

The invention is directed to a production method of a metal workpiece, so that a three-dimensional pattern is formed on the metal workpiece.

An embodiment of the invention provides a production method of a metal workpiece. An adhesive layer is applied on a metal workpiece. The adhesive layer is impressed by a mold so as to form a three-dimensional pattern. The adhesive layer is cured by implementing a plurality of heat treatments thereon.

In light of the foregoing, in the embodiments of the invention, the three-dimensional pattern is formed by applying the adhesive layer on the metal workpiece and impressing the mold on the adhesive layer. As a consequence, the technical requirements for forming three-dimensional pattern on metal workpiece are lowered effectively. Moreover, the readily production also increases the production efficiency of the metal workpiece.

Additionally, the main reasons of applying the invention to metal parts are as follows:

1. Post-Processing: the production method of the invention is applied to a flat workpiece to produce three-dimensional patterns thereon, and then a press molding is applied to the flat workpiece.

2. Temperature: the temperature of the primer selected in the invention is about 170° C., and the temperature of the common plastic ranges 90 degrees Celsius (polycarbonate, PC) to 160 degrees Celsius (acrylonitrile-butadiene-styrene, ABS). Therefore, the production method of the invention is not suitable for plastic casing.

In order to make the aforementioned and other features and advantages of the invention more comprehensible, embodiments accompanying figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIGS. 1-4 are flow diagrams of a production method of a metal workpiece according to an embodiment of the invention.

FIG. 5 is a schematic view of a metal workpiece according to another embodiment of the invention.

FIG. 6 is a schematic view of a metal workpiece according to another embodiment of the invention.

### DESCRIPTION OF EMBODIMENTS

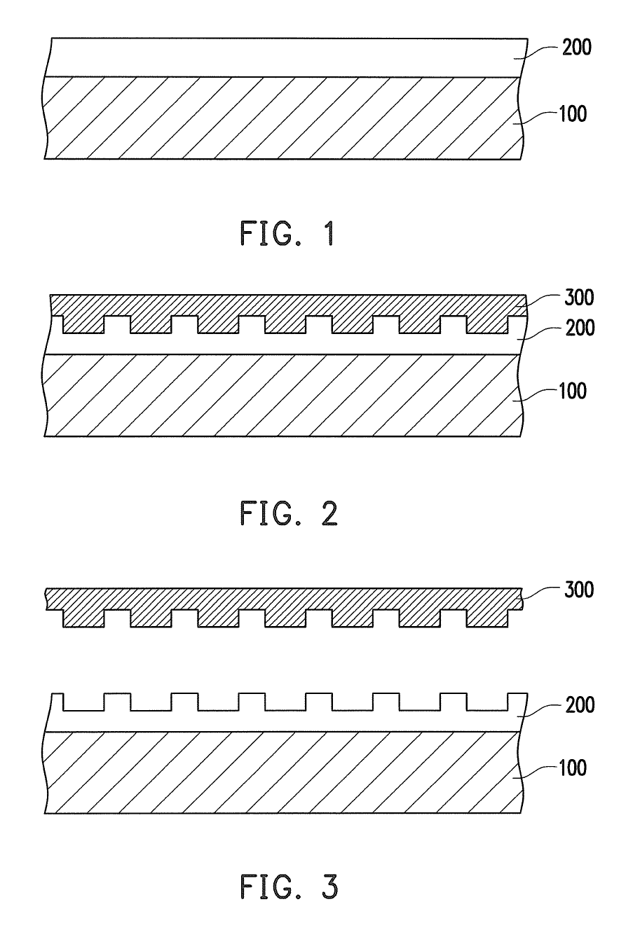

FIGS. 1-4 are flow diagrams of a production method of a metal workpiece according to an embodiment of the invention. Referring to FIGS. 1-4, in the present embodiment, an adhesive layer 200 is applied on a metal workpiece 100. The adhesive layer 200 is impressed by a mold 300, where the adhesive layer 200 is cured simultaneously. Upon completion, the mold 300 is removed so as to form a three-dimensional pattern on the metal workpiece 100.

In the present embodiment, the metal workpiece 100 is made of, for example, aluminum alloy (5052), stainless steel (430, 304), cold rolling steel (spcc), magnesium alloy (AZ91D, AZ61) or other metal materials suitable for constituting the exterior. Before the adhesive layer 200 is applied on the metal workpiece 100, pre-treatment processes such as degreasing and baking are first performed to the metal workpiece 100 to ensure impurities that prevent the adhesive layer 200 from adhering to the metal workpiece 100 are eliminated.

After being applied on the metal workpiece 100, the adhesive layer 200 is suitably baked and heated to reduce the fluidity thereof. The mold 300 having a three-dimensional pattern is provided and the mold 300 is usually made of transparent material so as to be pervious to light. A three-dimensional pattern complementary to the pattern of the mold 300 can be formed on the adhesive layer 200 by impressing the mold 300 on the semi-dry adhesive layer 200. The adhesive layer 200 is then cured by photo-curing or thermal-curing depending on the type of the adhesive layer 200 used, wherein photo-curing may be applied by UV irradiating, thermal-curing may be applied by heat baking, and the operating parameters may be adjusted based on actual conditions. Generally, thermal-curing may be applied to a batch by baking them in a large oven, and the baking temperature ranges 150 to 200 degrees Celsius.

Additionally, the photo-curing process includes two parts as follows. Firstly, when the mold 300 is impressed on the adhesive layer 200, the adhesive layer 200 is irradiated with UV of lower energy intensity (200 to 300 mj/cm²) to keep the shape of the three-dimensional patterns of the adhesive layer 200. Secondly, when the mold 300 is moved away from the adhesive layer 200, the adhesive layer 200 is irradiated with UV of higher energy intensity (1000 to 1200 mj/cm²) to fix the shape of the three-dimensional patterns of the adhesive layer 200.

Either photo-curing or thermal-curing is a heat treatment so that photo-curing and thermal-curing may be used together. In an example, photo-curing is used to keep the shape of the shape of the three-dimensional patterns of the adhesive layer 200, and thermal-curing is then used to fix the shape thereof. In another example, thermal-curing is used to keep the shape of the shape of the three-dimensional patterns of the adhesive layer 200, and photo-curing is then used to fix the shape thereof.

In the present embodiment, the metal workpiece 100 is, for instance, a metal plate. Thus, in the process of producing this metal workpiece 100, the production efficiency of the metal workpiece 100 can enhanced by transporting and processing with a roller apparatus.

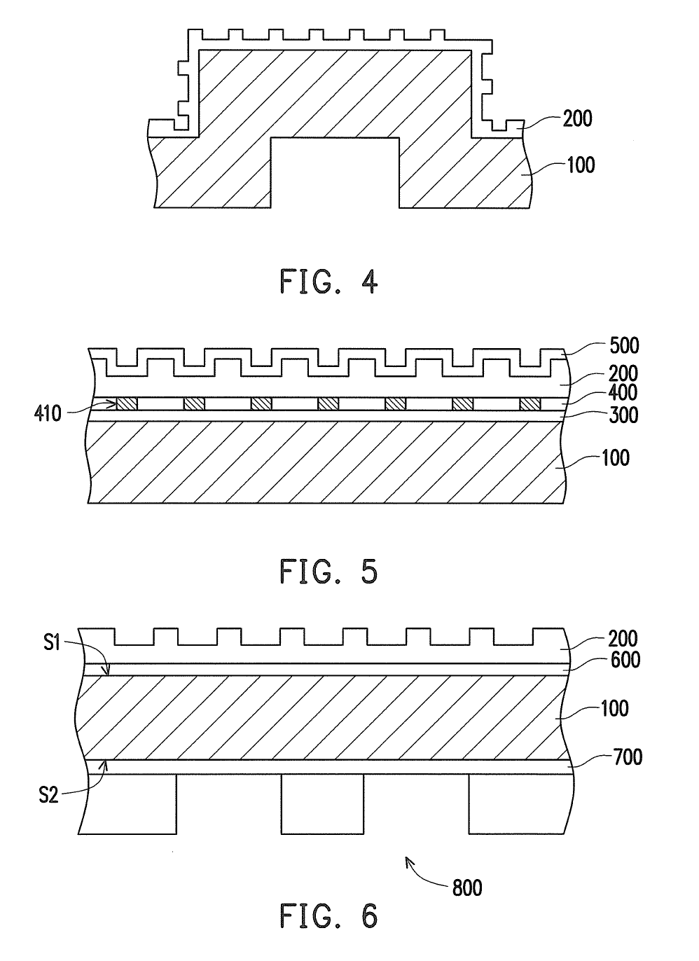

Referring to FIGS. 3 and 4, when the adhesive layer 200 is cured and the mold 300 is removed, the appealing configuration of the metal workpiece 100 produced from the roller apparatus is further processed using a punching apparatus so as to punch the metal workpiece 100 from a plate state into a three-dimensional workpiece. Accordingly, the metal workpiece 100 of the present embodiment first forms the three-dimensional pattern in the plate state by using the above technique, and the metal workpiece 100 is then processed by the punching apparatus depending on the configuration required. Consequently, the technical difficulty of forming the three-dimensional pattern on the surface of the three-dimensional workpiece is overcome, and the suitability of the metal workpiece 100 is further increased.

FIG. 5 is a schematic view of a metal workpiece according to another embodiment of the invention. Unlike the above embodiment, before the adhesive layer 200 is applied on the metal workpiece 100, a primer layer 300 is first applied on the metal workpiece 100 and then heated to about 170 degrees Celsius for adhering the adhesive layer 200 and the metal workpiece 100. In addition, in the present embodiment, a color layer 400 is further disposed on the primer layer 300, so as to color the metal workpiece 100. The method of coloring the metal workpiece 100 is not limited in the present embodiment, and the color layer 400 can be disposed on the primer layer 300 by applying, screen printing, offset printing or intaglio printing. The color layer 400 may has two-dimensional patterns 410, which and the three-dimensional patterns are continuous at bending portions of the metal workpiece 100. The thickness of portions of the adhesive layer 200 at bending portions of the metal workpiece 100 is less than the thickness of portions of the adhesive layer 200 at flat portions of the metal workpiece 100. Therefore, the three-dimensional patterns of the adhesive layer 200 and the two-dimensional patterns 410 can generate three-dimensional visual effects of pattern or grating by interference. After the adhesive layer 200 is cured, a passivation layer 500 is disposed thereon to prevent the following punching process from damaging the surface of the metal workpiece 100.

FIG. 6 is a schematic view of a metal workpiece according to another embodiment of the invention. Referring to FIG. 6, in the present embodiment, the metal workpiece 100 has a first surface S1 and a second surface S2 disposed in a back to back manner. Before the adhesive layer 200 is applied, a first primer layer 600 and a second primer layer 700 are applied on the first surface S1 and the second surface S2 respectively. Consequently, the first surface S1 and the second surface S2 of the metal workpiece 100 are adhesive. Thereafter, the adhesive layer 200 is applied on the first primer layer 600. After the adhesive layer 200 is cured, a plurality of three-dimensional components 800 are formed on the second primer layer 700 on the second surface S2 of the metal workpiece 100 by using the injection molding technique. These three-dimensional components 800 are, for example, a plurality of bosses for assembling other components on the metal workpiece 100 conveniently.

On the other hand, referring to FIGS. 5 and 6 simultaneously, in the embodiment shown in FIG. 6, the first primer layer 600 is a color primer layer, where a color dye is added to the primer layer 600, for example. Thus, the metal workpiece 100 is colored without having additional color layer 400 printed on the primer layer 300 in FIG. 5.

In summary, in the aforementioned embodiments of the invention, the three-dimensional pattern is formed on the metal workpiece by applying the adhesive layer on the metal workpiece and impressing the adhesive layer with the mold. Accordingly, the technical difficulty of forming the three-dimensional pattern on the metal workpiece is effectively reduced. Moreover, the production of the three-dimensional pattern can be performed when the metal workpiece is in the plate state. After the production is complete, the metal workpiece is punched to form the three-dimensional workpiece, or a plurality of three-dimensional components is injection molded on the other side. The metal workpiece thus has lower production cost and higher suitability.

In addition, a three-dimensional workpiece is formed by punching a metal plate. The three-dimensional patterns formed by the adhesive layer are continuous at bending portions of the metal plate, and the thickness of portions of the adhesive layer at bending portions of the metal plate is less than the thickness of portions of the adhesive layer at flat portions of the metal plate. Therefore, the three-dimensional patterns and the two-dimensional patterns of the color layer therebelow can generate three-dimensional visual effect of pattern or grating by interference.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A production method of a metal workpiece, the production method comprising:
applying an adhesive layer on a metal workpiece;
impressing the adhesive layer by using a mold, so that the adhesive layer forms a three-dimensional pattern; and
curing the adhesive layer by implementing a plurality of heat treatments thereon.

2. The production method of the metal workpiece as claimed in claim 1, further comprising:
applying a primer layer on the metal workpiece before applying the adhesive layer, wherein the primer layer is heated to about 170 degrees Celsius.

3. The production method of the metal workpiece as claimed in claim 2, further comprising:
disposing a color layer on the primer layer, wherein the color layer has a two-dimensional pattern.

4. The production method of the metal workpiece as claimed in claim 2, wherein the primer layer is a color primer layer, and the color primer layer has a two-dimensional pattern.

5. The production method of the metal workpiece as claimed in claim 2, wherein the metal workpiece has a first surface and a second surface disposed in a back to back manner, the primer layer comprises a first primer layer and a second primer layer, the first primer layer and the second primer layer are applied on the first surface and the second surface respectively, and the adhesive layer is applied on the first primer layer on the first surface.

6. The production method of the metal workpiece as claimed in claim 5, further comprising:
injection molding a three-dimensional component on the second primer layer on the second surface after curing the adhesive layer.

7. The production method of the metal workpiece as claimed in claim 1, further comprising:
removing the mold after curing the adhesive layer; and
disposing a passivation layer on the adhesive layer.

8. The production method of the metal workpiece as claimed in claim 1, wherein the metal workpiece is a metal plate.

9. The production method of the metal workpiece as claimed in claim 8, further comprising:
removing the mold after curing the adhesive layer; and
punching the metal plate, so that the metal plate forms a three-dimensional workpiece.

10. The production method of the metal workpiece as claimed in claim 1, wherein the heat treatment is light irradiation or heating.

11. The production method of the metal workpiece as claimed in claim 1, wherein the step of curing the adhesive layer comprising:
irradiating the adhesive layer with a first UV to keep the shape of the three-dimensional pattern of the adhesive layer when the adhesive layer is impressed by the mold; and
irradiating the adhesive layer with a second UV to fix the shape of the three-dimensional pattern of the adhesive layer when the mold is moved away from the adhesive layer.

12. The production method of the metal workpiece as claimed in claim 11, wherein the irradiating energy intensity of the second UV is higher than the irradiating energy intensity of the first UV.

13. The production method of the metal workpiece as claimed in claim 12, wherein the energy intensity of the first UV ranges 200 to 300 mj/cm², and the energy intensity of the second UV ranges 1000 to 1200 mj/cm².

14. The production method of the metal workpiece as claimed in claim 1, wherein a pre-treatment process of degreasing is performed to the metal workpiece.

15. The production method of the metal workpiece as claimed in claim 1, wherein the mold is a transparent mold.

16. A metal workpiece with three-dimensional pattern, comprising:
a metal workpiece; and
an adhesive layer disposed on the metal workpiece, wherein the adhesive is impressed by a mold to form a three-dimensional pattern, and the adhesive is cured by light irradiating or heating to fix the shape of the three-dimensional pattern of the adhesive.

17. The metal workpiece with three-dimensional pattern as claimed in claim 16, further comprising:
a primer layer disposed between the metal workpiece and the adhesive layer.

18. The metal workpiece with three-dimensional pattern as claimed in claim 17, further comprising:
a color layer disposed between the primer layer and the adhesive layer.

19. The metal workpiece with three-dimensional pattern as claimed in claim 18, wherein the color layer has a two-dimensional pattern which and the three-dimensional pattern forms three-dimensional visual effect.
